(19) United States
(12) Patent Application Publication
(10) Pub. No.: US 2010/0097331 A1
(43) Pub. Date: Apr. 22, 2010

(54) ADAPTIVE USER INTERFACE

(75) Inventor: WEN-YI WU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (SHENZHEN) CO., LTD, Shenzhen City (CN); HON HAI PRECISION INDUSTRY CO., LTD., Tu-Cheng (TW)

(21) Appl. No.: 12/334,720

(22) Filed: Dec. 15, 2008

(30) Foreign Application Priority Data
Oct. 16, 2008 (CN) 200810304943.8

(51) Int. Cl. G06F 3/041

(52) U.S. Cl. 345/173

(57) ABSTRACT

A method of activating and displaying a user interface (UI) integrated in an electronic device includes detecting a right-handed or a left-handed grip of the electronic device and activating a right-handed or a left-handed UI responding to the right-handed or left-handed grip. The right handed UI mirrors the left-handed UI.

### BACKGROUND

1. Technical Field

The present disclosure relates to a method providing an adaptive user interface and an electronic device using the same.

2. Description of Related Art

Typically, user interfaces (UIs) are fixed in arrangements oriented toward right-handed users on hand-held multimedia devices such as mobile phones. Unfortunately, left-handed users may not be able to fully adapt to right-handed UIs. Therefore, a need exists for an adaptive UI of an electronic device.

### BRIEF DESCRIPTION OF THE DRAWINGS

FIG. 1 is a view of an embodiment of an electronic device, the electronic device displaying a right-handed alpha-numeric input user interface.

FIG. 2 is similar to FIG. 1, but depicts a right-handed operating system user interface on the electronic device.

FIG. 3 is similar to FIG. 1, but depicts a left-handed input alpha-numeric input user interface.

FIG. 4 is similar to FIG. 2, but depicts a left-handed operating system user interface on the electronic device.

FIG. 5 is a flowchart of an embodiment of a method of activating user interfaces of the electronic device.

### DETAILED DESCRIPTION OF THE EMBODIMENTS

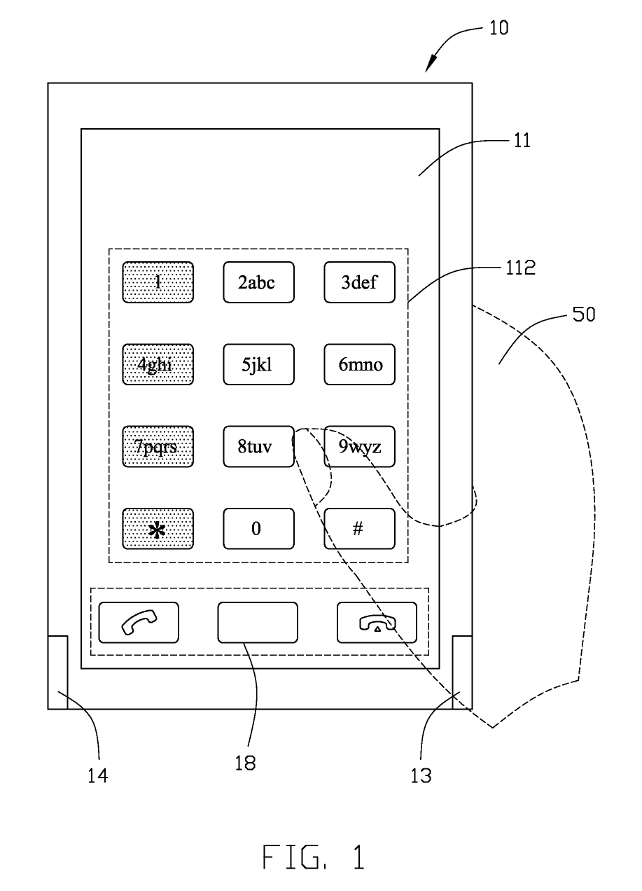

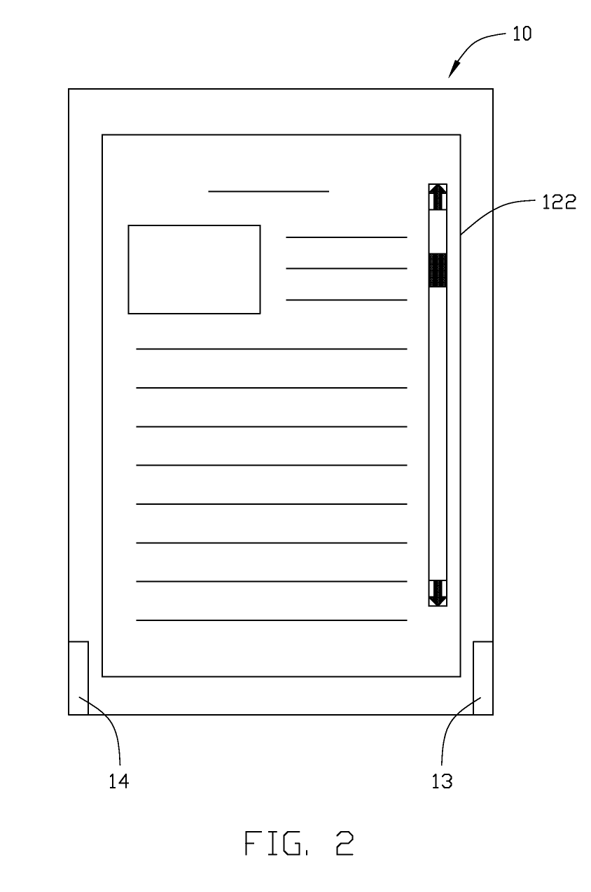

Referring to FIG. 1 and FIG. 2, a right handed alpha-numeric user interface (UI) 112 and a right handed operation system UI 122 are respectively depicted in a touch-screen display 11 of an embodiment of an electronic device 10 for a user 50. A right hand sensor 13 is positioned at a lower right potion of the electronic device 10 to detect if a right hand is being used by the user. A left hand sensor 14 is positioned at a lower left portion of the electronic device 10 to detect if a left hand is being used by the user.

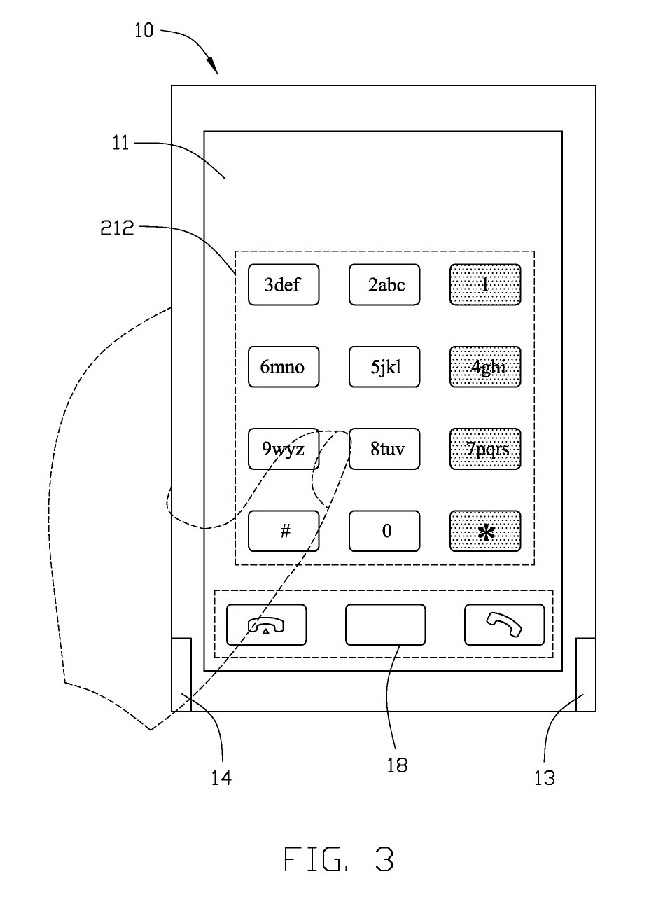

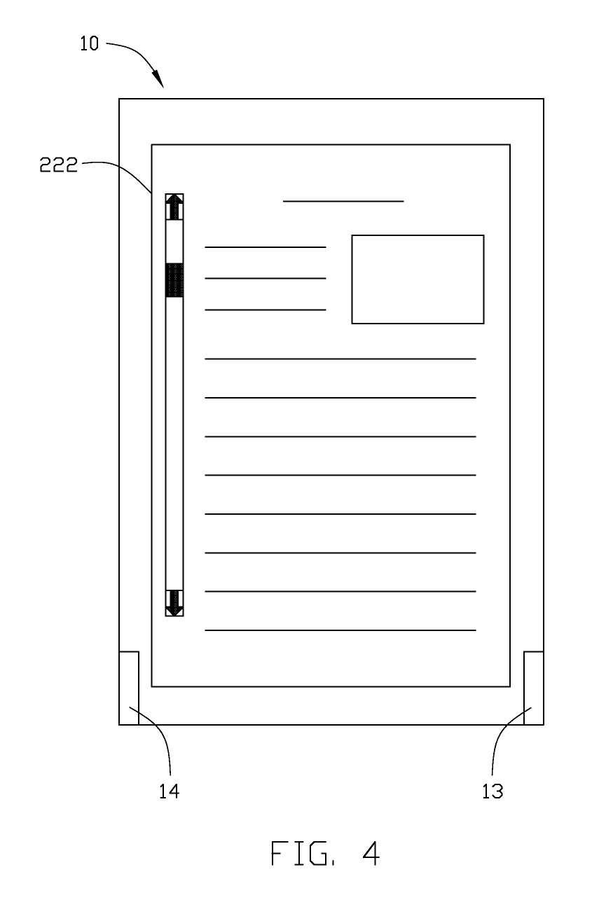

Referring to FIG. 3 and FIG. 4, a left-handed alpha-numeric UI 212 and a left handed operation system UI 222 are respectively depicted in the touch-screen display 11. In the illustrated embodiment, the left-handed UIs 212, 222 mirror the right-handed UIs 112, 122.

An embodiment of a method allows the electronic device 10 to detect if the user grasps the device 10 with the right hand or the left hand via the sensors 13, 14. The electronic device 10 displays the right-handed UIs 112, 122 if the sensor 13 senses the right hand is being used by the user. The electronic device 10 displays the left-handed UIs 212, 222 if the sensor 14 senses the left hand is being used by the user. For example, if the electronic device 10 is in a mode to make phone calls and a user grasps the phone from the lower right side indicating a right-handed use, the sensor 13 is activated and the right-handed alpha-numeric UI 112 is activated and displayed for use. In addition, the user may input a command through the use of, for example, a function key 18, that allows the user to select any one of the UIs regardless of how the electronic device 10 is gripped.

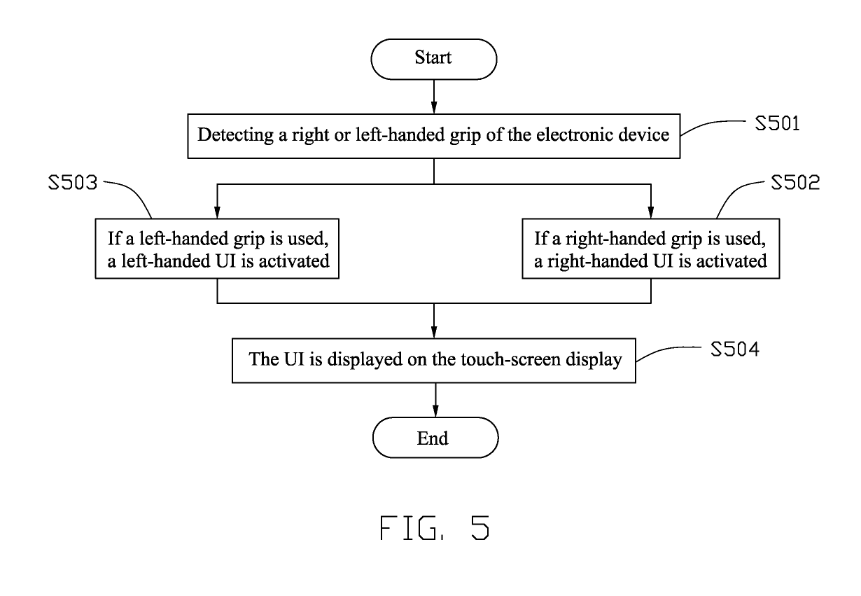

FIG. 5 is a flowchart of an embodiment of a method for activating and displaying UIs in the touch-screen display 11 of the electronic device 10 corresponding to how the user grips the electronic device 10. Depending on the embodiment, certain of the blocks described below may be removed, others may be added, and the sequence of blocks may be altered.

In block S501, one of the sensors 13, 14 of the electronic device 10 is activated by a right or left-handed grip of the electronic device 10 by a user. If a right-handed grip is used, the sensor 13 is activated, and the method continues to block S502. In block S502, a corresponding right-handed UI is activated, and the method continues to block S504. If a left-handed grip is used, the sensor 23 is activated, and the method continues to block S503. In block S503, a corresponding left-handed UI is activated, and the method continues to block S504. In block S504, the activated UI is displayed on the touch-screen display.

It is to be understood, however, that even though numerous characteristics and advantages of the present embodiments have been set forth in the foregoing description, together with details of the apparatus and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A method, comprising:
providing an electronic device, wherein a user interface (UI) is integrated in the electronic device;
detecting a right-handed or a left-handed grip of the electronic device; and
activating a right-handed UI if a right-handed grip is used or a left-handed UI if a left-handed grip is used, wherein the right-handed UI mirrors the left-handed UI.

2. The method of claim 1, further comprising displaying the activated UI on a touch-screen display of the electronic device.

3. The method of claim 1, wherein the right-handed grip is detected by a right sensor positioned on a lower right portion of the electronic device.

4. The method of claim 1, wherein the left-handed grip is detected by a left sensor positioned on a lower left portion of the electronic device.

5. The method of claim 1, wherein the left-handed grip or the right-handed grip is triggered by a functional key in UI.

6. A computer program stored on a computer readable medium, the computer program with instructions operable to cause a processor to detect a right-handed or a left-handed grip of the electronic device, and activating a right-handed UI if a right-handed grip is used or a left-handed UI if a left-handed grip is used.

7. An electronic device, comprising a touch-screen display; and a left sensor configured to detect a left-handed grip, wherein a right-handed UI is displayed on the touch-screen display; a left-handed UI is displayed on the touch-screen display on the touch-screen display if the left-handed grip is detected; the left-handed UI mirrors the right-handed UI.

8. The electronic device of claim 7, wherein the UI comprises an alpha-numeric UI.

9. The electronic device of claim 7, wherein the UI comprises an operation system UI.
